(19) United States
(12) Patent Application Publication
(10) Pub. No.: US 2022/0036624 A1
(43) Pub. Date: Feb. 3, 2022

(54) ANIMATION PRODUCTION SYSTEM

(71) Applicant: AniCast RM Inc., Minato-ku (JP)

(72) Inventors: Yoshihito KONDOH, Chuo-ku (JP); Masato MUROHASHI, Tokyo (JP)

(21) Appl. No.: 17/008,410

(22) Filed: Aug. 31, 2020

(30) Foreign Application Priority Data
Jul. 29, 2020 (JP) 2020-128310

(51) Int. Cl. G06T 13/40; G06T 19/20

(52) U.S. Cl. CPC G06T 13/40; G06T 19/20; G06F 3/012; G06T 2219/2016; G06T 2200/24; G06T 2219/2004

(57) ABSTRACT

To reduce the burden of animation production, a system for producing an animation in a virtual space, the system comprising: an asset management unit that places a first object and a second object in the virtual space; and a control unit that adjusts size of the second object in accordance with size of the first object

### TECHNICAL FIELD

The present invention relates to an animation production system.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

In creating animations in a virtual space, it is necessary to adjust the size of virtual objects (for example, objects using characters or everyday items as motifs). However, it is extremely burdensome for the creator to adjust the size of all objects independently, and this reduces the efficiency and immersion of animation production.

The present invention has been made in view of this background, and is intended to provide a technology that can reduce the burden of animation production.

### Solution to Problem

The main invention for solving the above-described problems is a system for producing an animation in a virtual space, the system comprising: an asset management unit that places a first object and a second object in the virtual space; and a control unit that adjusts size of the second object in accordance with size of the first object.

The other problems disclosed in the present application and the method for solving them are clarified in the sections and drawings of the embodiments of the invention.

### Advantageous Effects of Invention

According to the present invention, the burden of animation production can be reduced.

### BRIEF DESCRIPTION OF DRAWINGS

FIG. 1 is a diagram illustrating an example of a virtual space displayed on an HMD mounted by a user in an animation production system of the present embodiment;

FIG. 2 is a diagram illustrating an example of an overall configuration of an animation production system according to an embodiment of the present invention.

FIG. 3 is a schematic view illustrating an appearance of an HMD according to the present embodiment;

FIG. 4 is a diagram illustrating an example of a functional configuration of an HMD according to the present embodiment;

FIG. 5 shows a schematic view of the appearance of the controller according to the present embodiment.

FIG. 6 is a diagram illustrating an example of a functional configuration of a controller according to the present embodiment;

FIG. 7 is a diagram illustrating a functional configuration example of an image producing device according to the present embodiment;

FIG. 8 is a diagram illustrating the removal of an object from an asset store in an animation production system according to the present embodiment;

FIG. 9 is a diagram illustrating an example of an automatic adjustment of the size of an object in an animation production system according to the present embodiment;

FIG. 10 is a diagram illustrating an example of an automatic adjustment of the size of an object in an animation production system according to the present embodiment;

FIG. 11 is a diagram illustrating an example of an automatic adjustment of the size of an object in an animation production system according to the present embodiment;

FIG. 12 is a diagram illustrating an optimization when a user possesses a character in an animation production system according to the present embodiment;

FIG. 13 is a diagram illustrating an optimization when using motion data as a character in the present embodiment.

FIG. 14 is a diagram illustrating an example of a physical interaction between objects in an animation production system of the present embodiment;

FIG. 15 is a diagram illustrating an example of a physical interaction between objects in an animation production system of the present embodiment;

### DESCRIPTION OF EMBODIMENTS

The contents of embodiments of the present invention will be described with reference. The present invention includes, for example, the following configurations.

[Item 1]

A system for producing an animation in a virtual space, the system comprising:

an asset management unit that places a first object and a second object in the virtual space; and

a control unit that adjusts size of the second object in accordance with size of the first object.

[Item 2]

The animation production system according to claim 1, wherein the control unit adjusts the height of the second object in accordance with the height of the first object.

[Item 3]

The animation production system according to claim 1 or 2, wherein

a camera is disposed in the aforementioned virtual space,

the control section adjusts the size of the second object in response to a first object and a field angle of the camera.

[Item 4]

The animation production system according to claim 3, wherein the controller adjusts the size of the second object to a size equal to or greater than the image angle of the camera.

[Item 5]

The animation production system according to any one of claims 1 to 4, further comprising a storage unit for storing size data of the first object and the second object, wherein the control unit adjusts the size of the second object using a ratio obtained from the size data of the first object stored in the storage unit and the size of the first object in the virtual space.

[Item 6]

The animation production system of claim 5, wherein the size data is height data.

A specific example of an animation production system 300 according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### Overview

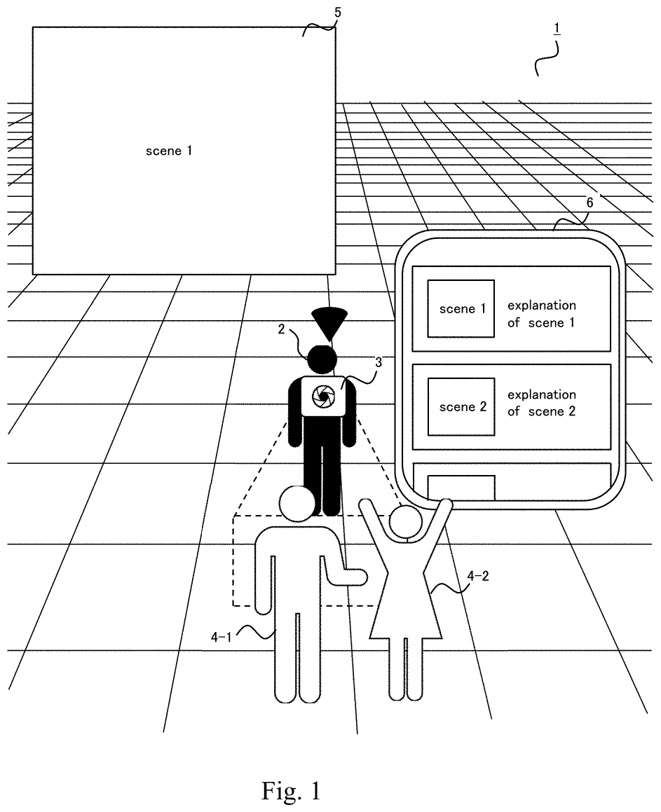

FIG. 1 is a diagram illustrating an example of a virtual space displayed on a head mount display (HMD) mounted by a user in an animation production system 300 according to the present embodiment. In the animation production system 300 of the present embodiment, the virtual camera 3 and the virtual character 4 (the first object) and the virtual object 5 (the second object) are arranged in the virtual space 1, and the character 4 is shot using the camera 3. In the virtual space 1, a photographer 2 (a photographer character) is disposed, and the camera 3 is virtually operated by the photographer 2. In addition, the asset store 6 is installed in the virtual space 1, and depending on the possession described later, the user acquires the scene object 5 of the asset store 6 as a photographer 2 or a character 4 (e.g., picking it by hand) and can use the object for photographing.

In the animation production system 300 of the present embodiment, as shown in FIG. 1, a user makes an animation by arranging a character 4, an object 5, and a camera 3 while viewing the virtual space 1 from a bird's perspective using a TPV (Third Person's View), shooting a character 4 as a photographer 2 using FPV (First Person View; first person's perspective), or performing a character 4 using an FPV. The user can also perform the performance while possessing the character 4. If more than one character 4 is disposed, the user may also switch the object possessed by each character 4 (e.g., characters 4-1 and 4-2). That is, in the animation production system 300 of the present embodiment, one can play a number of roles (roles). In addition, since the camera 3 can be virtually operated as the photographer 2, natural camera work can be realized and the representation of the movie to be shot can be enriched.

<General Configuration>

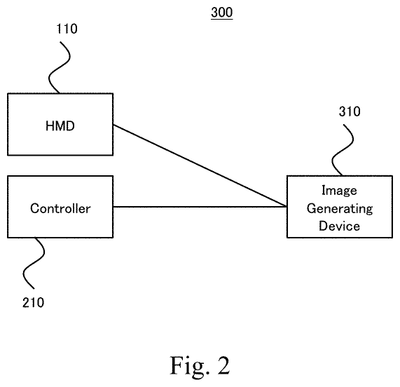

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. An infrared camera (not shown) or the like can also be added to the animation production system 300 for detecting the position, orientation and slope of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth™, WiFi™. The image generating device 310 may be a PC, a game machine, a portable communication terminal, or any other device having a calculation processing function.

<HMD 110>

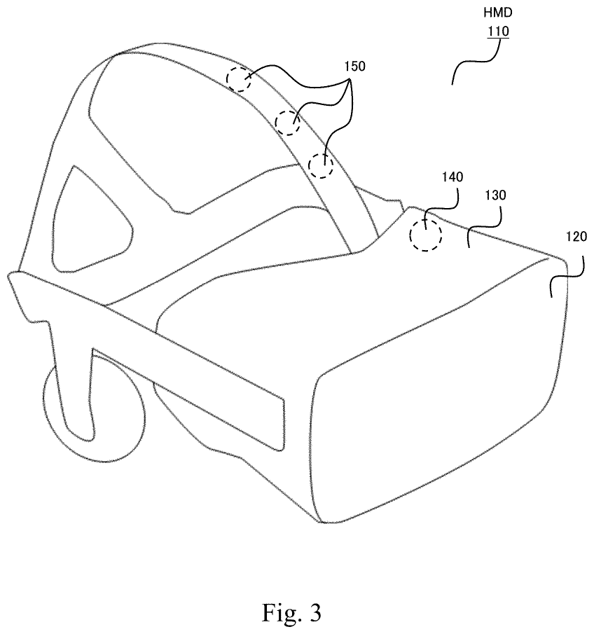

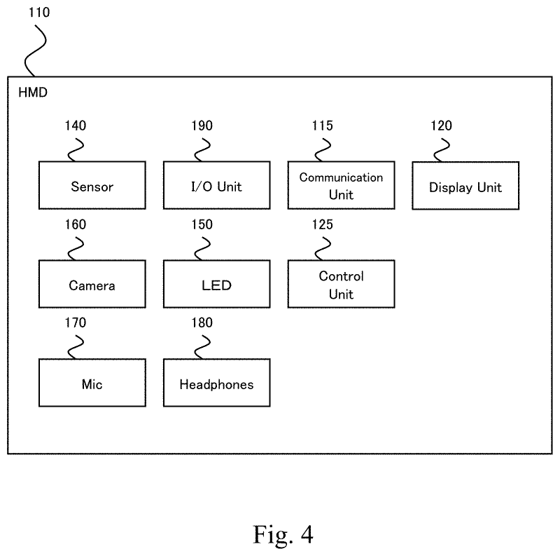

FIG. 3 shows a schematic view of the appearance of the HMD 110 according to the present embodiment. FIG. 4 is a diagram illustrating an example of a functional configuration of the HMD 110 according to the present embodiment.

The HMD 110 is mounted on the user's head and includes a display panel 120 for placement in front of the user's left and right eyes. Although an optically transmissive and non-transmissive display is contemplated as the display panel, this embodiment illustrates anon-transmissive display panel that can provide more immersion. The display panel 120 displays a left-eye image and a right-eye image, which can provide the user with a three-dimensional image by utilizing the visual difference of both eyes. If left- and right-eye images can be displayed, a left-eye display and a right-eye display can be provided separately, and an integrated display for left-eye and right-eye can be provided.

The housing portion 130 of the HMD 110 includes a sensor 140. Sensor 140 may comprise, for example, a magnetic sensor, an acceleration sensor, or a gyro sensor, or a combination thereof, to detect movements such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e.g., infrared light LEDs, visible light LEDs). A camera (e.g., an infrared light camera, a visible light camera) installed outside the HMD 110 (e.g., indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

<Controller 210>

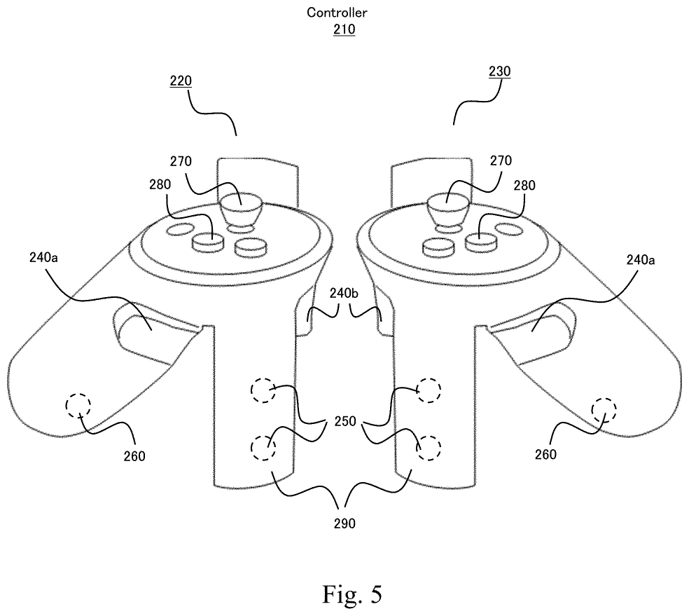

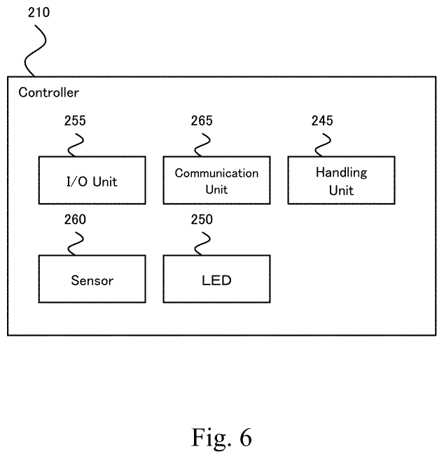

FIG. 5 shows a schematic view of the appearance of the controller 210 according to the present embodiment. FIG. 6 is a diagram illustrating an example of a functional configuration of a controller 210 according to this embodiment.

The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect movements such as the orientation and tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the movement and attitude of the user's hand, pseudo-displaying and operating the user's hand in the virtual space.

<Image Generator 310>

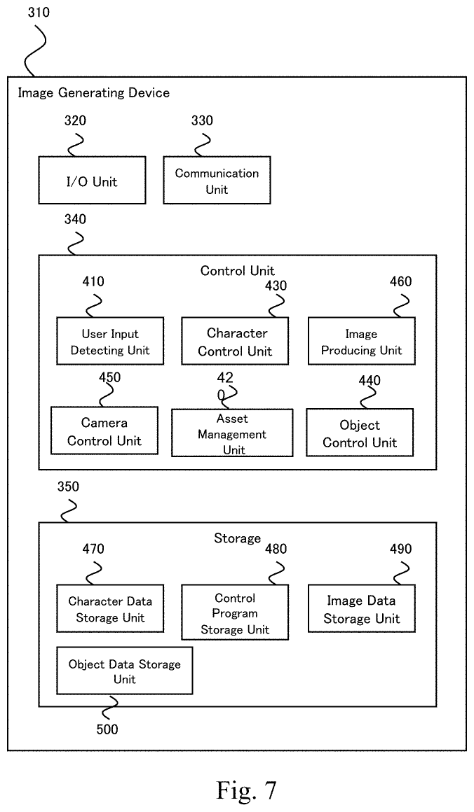

FIG. 7 is a diagram illustrating a functional configuration of an image producing device 310 according to the present embodiment. The image producing device 310 may use a device such as a PC, a game machine, a portable communication terminal, or the like, which has a function for storing information on the user's head movement or the movement or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110 and/or the controller 210 regarding the movement of the user's head or the movement or operation of the controller is detected in the control unit 340 as input content including the operation of the user's position, line of sight, attitude, speech, operation, etc. through the I/O unit 320 and/or the communication unit 330, and a control program stored in the storage unit 350 is executed in accordance with the user's input content to perform a process such as controlling the character 4 or the object 5 and generating an image. In addition, the object 5 can be controlled to operate in addition to the user's input contents. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 controls and computes each part. Specifically, the control section includes a user input detecting unit 410 that detects information on movement of the user's head and/or user speech received from the HMD 110 and/or the controller 210, a user input detecting unit 410 that detects information on movement and operation of the controller, an asset management unit 420 for generating and arranging the character 4 and the object 5 in the virtual space, a character 4 and an object 5 in a virtual space, a character control unit 430 that executes a control program stored in the control program storage unit 480 for a character data storage unit 470 of the storage unit 350, an object control unit 440 that executes a control program stored in the control program storage unit 480 for an object 5 stored in the object data storage unit 500 of the storage unit 350, a camera control unit 450 that controls the virtual camera 3 disposed in the virtual space 1 in accordance with the character control, and an image producing unit 460 that generates an image in which the camera 3 captures the virtual space 1 based on the character control and/or object control. Here, the movement of the character 4 is controlled by converting information such as the direction, inclination, and hand movement of the user head detected through the HMD 110 or the controller 210 into the movement of each part of the bone structure created in accordance with the movement or restriction of the joints of the human body, and applying the bone structure movement to the previously stored character data. The control of the camera 3 is performed, for example, by changing various settings for the camera 3 (for example, the position within the virtual space 1 of the camera 3, the viewing direction of the camera 3, the focus position, the zoom, etc.) depending on the movement of the hand of the character 4.

The storage unit 350 stores in the character data storage unit 470 the attribute information of the character 4, as well as the size data of the character 4 in the real world, such as height, body size, etc. (for example, size data such as height of 160 cm and shoulder width of 40 cm). Further, the control program storage unit 480 controls the operation or expression of the character 4 in the virtual space and stores a program for controlling the camera 3, the object 5, or the like. The image data storage unit 490 stores the image generated by the image producing unit 460. In the object data storage unit 500, in addition to the image data of the object 5, information related to the object 5 (for example, size data such as height, width, volume, etc. in the real world, operation details, operation period, etc.) is stored.

<Auto Size Adjustment>

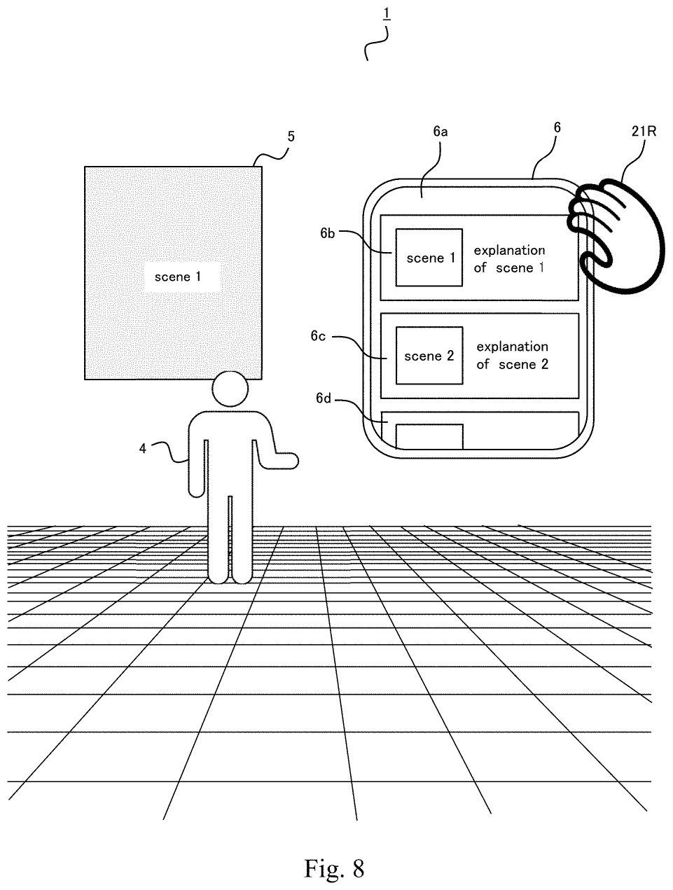

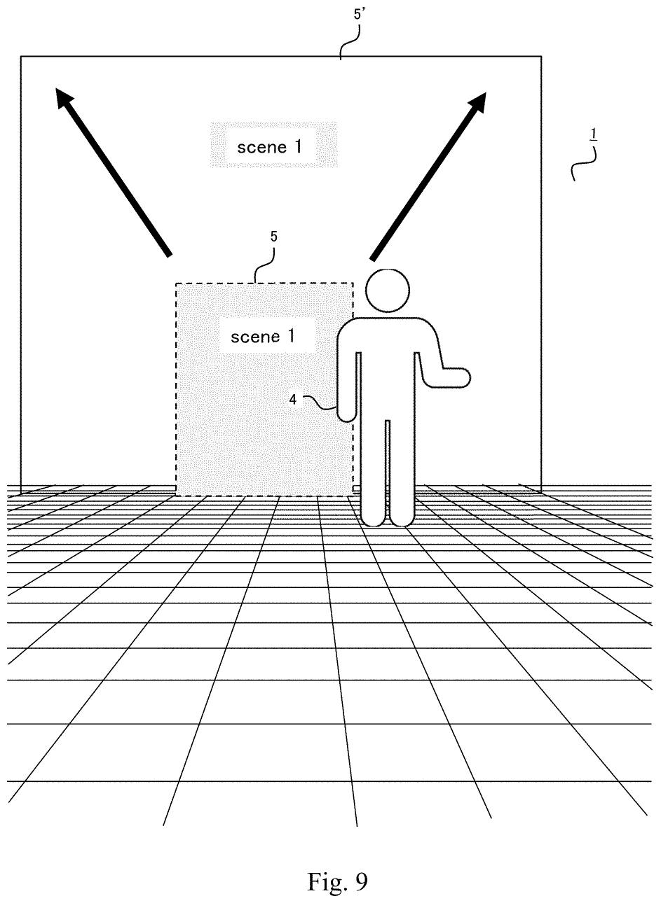

Next, FIG. 8 is a diagram illustrating an example of an automatic adjustment of the size of an object in an animation production system according to the present embodiment, and FIG. 9-11 is a diagram illustrating an example of an automatic adjustment of the size of an object in an animation production system according to the present embodiment, and an automatic adjustment of the size in an object will be described with reference to the following figures.

First, as shown in FIG. 8, a user may utilize an asset store 6 disposed on the virtual space 1 by manipulating, for example, a photographer 2 or a character 4. The asset store 6 of the present embodiment is, for example, a virtual touch panel, and a scene asset 6b, 6c, and 6d for photography is disposed in the display portion 6a of the panel as an asset. Scenery assets 6b, 6c, and 6d are a set of scenic thumbnails and landscape descriptions. The user can also select a scene asset by sliding the panel vertically. Then, for example, the user can retrieve the scene object 5 into the virtual space 1 by pressing the scene asset 6b by the virtual right hand 21R in the virtual space 1. Assets disposed in the asset store 6 are not limited to scenic assets. For example, objects with motifs of everyday objects such as furniture and electrical appliances, or objects with motifs of decorative objects of character 4, etc. Assets located in the asset store 6 may also be periodically updated, arranged based on conditions set by the object condition window (not shown), or learned about the user's preferences and displayed an asset in accordance with the user's preferences, such as on the basis of a sales history. Assets disposed in the asset store 6 may be sold not only as a single object, but also as a set of objects of the same or different types combined. Additionally, the asset located in the asset store 6 may be data acquired from a server connected via a network, e.g., a cloud server.

In this embodiment, the landscape object 5 is a square plate-shaped object, which may be implemented by attaching to at least one side thereof an image representing scenery such as grassland, forests, streets, facilities, etc. as a texture. The scene object 5 can also be scaled down in the virtual space 1 by user operation. When a character 4 or the like is shot with a camera 3 against the background of a scenic object 5, a character 4 is displayed in the scenery in the shot image. During normal shooting, the user may arrange the scene object 5 in the virtual space 1 and adjust its position and size to set the background of, for example, the character 4.

Next, an adjustment of the size of the scene object 5 will be described with reference to FIG. 9. When a landscape object 5 (a second object) is disposed within a virtual space 1 with a character 4 (a first object), the control unit 340 can adjust the size of the scene object 5 so that the scene object 5 is of an appropriate size to the character 4.

For example, the control unit 340 may change the height of the scene object 5 so that the height of the scene object 5 is greater than or equal to the height of the character 4 in the virtual space 1. When the height of the scenic object 5 is lower than the value obtained by multiplying the height of the character 4 by a predetermined number (for example, 1.5 times, 2 times, etc.), the control unit 340 may change the height of the scenic object 5 to a value obtained by multiplying the height of the character 4 by the predetermined number. For example, when the height of the scenic object is lower than the value obtained by adding a predetermined value (for example, a pixel number such as 100 pixels may be specified or a pixel number may be specified depending on the resolution such as 10 cm) to the height of the character 4, the control unit 340 may change the height of the scenic object 5 to the value obtained by adding the predetermined number to the height of the character 4. The control unit 340 may change the width of the scene object 5 simultaneously so as to maintain the aspect ratio of the scene object 5 when changing the height of the scene object 5 as described above. Similar to the height, the controller 340 may also change the width of the scene object 5 such that, for example, the width of the scene object 5 is greater than or equal to the width of the character 4 in the virtual space 1. The controller 340 may also change the width and height of the scene object 5 while maintaining the aspect ratio of the scene object 5 such that, for example, the width and height of the scene object 5 are equal to or greater than the width and height of the scene object 5, respectively.

The controller 340 may also adjust the size of one object according to the size of the other object, taking into account the distance between the two objects. For example, the controller 340 may adjust the size of one object so that the closer the distance between the two objects is, the smaller the distance is. For example, the controller 340 may change at least one of the width and height of the scenic object 5 such that it is larger when the scenic object 5 is close to the character 4 and smaller when it is away from the character 4. In this case, as described above, the controller 340 may only change the height or width, or may change the width and height while maintaining the aspect ratio.

In addition, size data in a predetermined unit (e.g., meter) can be managed for each object, and the size data can be used to change the size of another object in the virtual space 1 based on the size of one object in the virtual space 1. For example, as the size data of the character 4, the height (e.g., 160 cm) is recorded, for example, the width and height of the wall included in the texture are recorded as the size data of the scene object 5 to which the texture of the image taken of the wall is attached, and the size (height and width) of the scene object 5 can be changed in accordance with the ratio of the height (reference ratio) in the predetermined unit (reference ratio) to the height of the character 4 in the coordinate system of the virtual space 1 (scene object 5′). In this embodiment, the size data of each object is managed, but it is not limited thereto. For example, a user may input size data using an input device (not shown). In the present embodiment, the reference ratio is the ratio of the height of the character to the height of the character 4 in the coordinate system of the virtual space in the above-described predetermined unit. However, the reference ratio may be obtained from an object other than the character. That is, if the size data is a defined object, the reference ratio may be used to resize other objects (including characters).

In this embodiment, the size adjustment of the scene object 5 has been described, but is not limited thereto. The control unit 340 can also adjust the size of an object with a motif such as a daily necessity.

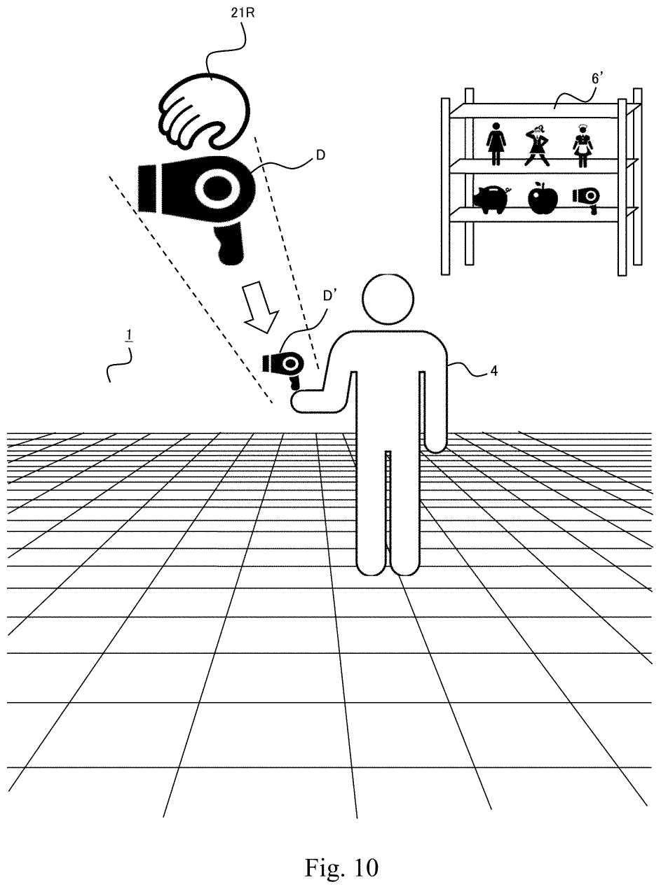

Specifically, FIG. 10 will be illustrated and described. The figure shows a shelf-shaped set store 6′, a character 4, and an article object (dryer D) motifed by a dryer. Asset store 6′ is shelf-shaped, with clothing and accessory objects decorating character 4 displayed as an asset in the upper stage of asset store 6′, and objects of daily necessities are arranged as assets in the lower stage. When the user removes the article object (dryer D) motifed by the dryer from the asset store 6′ by the virtual right hand 21R in the virtual space 1, the control unit 340 can perform the size adjustment (dryer D′) of the dryer D using the reference ratio obtained from the character 4 in the same manner.

<Auto Size Adjustment Depending on Camera Image Angle>

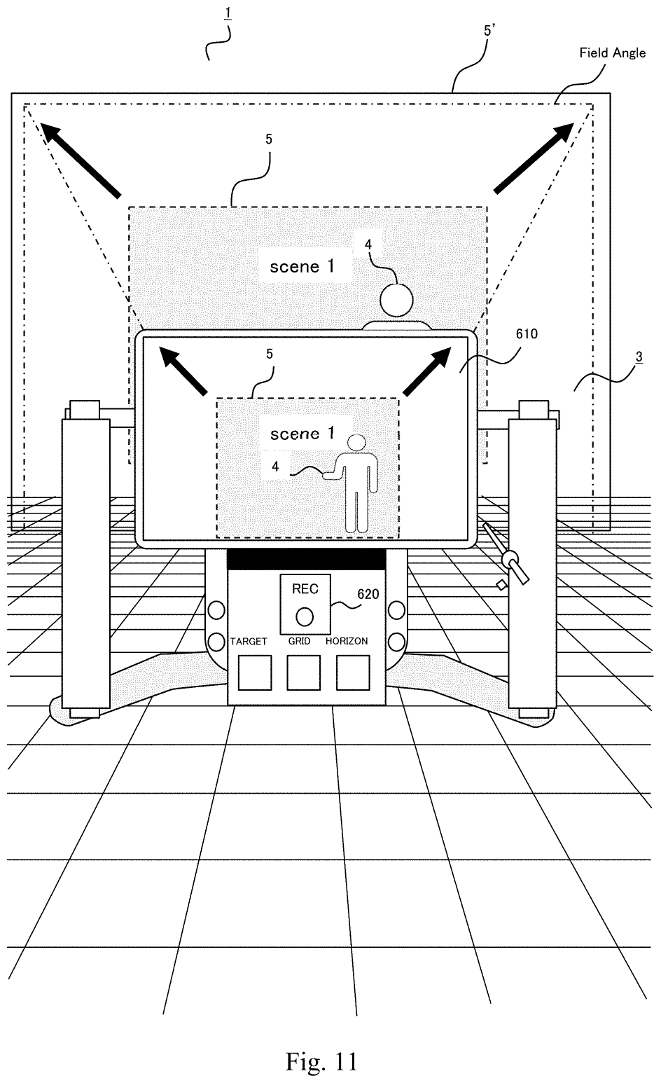

Next, the size adjustment of the object 5 when shooting with the camera 3 in the virtual space 1 will be described with reference to FIG. 11.

As shown in FIG. 11, the camera 3 in the virtual space 1 is used to take a character 4 and a scene object 5 while the user is possessing the camera 2. The display portion 610 of the camera 3 shows a character 4 and a scene object 5 before size adjustment. Accordingly, when the user presses the recording button 620 with the character 4 and the object 5 collimated using the camera 3, the control unit 340 adjusts the size when it is judged necessary to determine the necessity of size adjustment so that the scene object 5 can be formed. For example, when the control unit 340 determines that the scene object 5 displayed in the display unit 610 is smaller than the display range of the display unit 610, the control unit 340 expands the scene object 5 so that the scene object 5 displayed in the display unit 610 is equal to or more than the display range of the display unit 610 of the camera 3. That is, when the size of the scene object 5 falls within the range of the area angle of the camera 3 (a dotted line), the control unit 340 enlarges and adjusts the size of the scene object 5 so that the size of the scene object 5 exceeds the area of the image angle of the camera 3.

Further, the control unit 340 may adjust the size of the scene object 5 by considering the size of the character 4 in the virtual space 1, rather than using only the image angle of the camera 3 as a determining material. For example, even if it is judged that the size of the scene object 5 is equal to or larger than the square range of the camera 3, when it is judged that the size ratio of the character 4 is incompatible (e.g., when the size of the scene object 5 is smaller than the character 4), the control unit 340 may adjust the expansion of the scene object 5 by preferentially reference the size of the character 4 (using the reference ratio).

In this embodiment, it is stated that the size of the scene object 5 is adjusted according to the image angle of the camera 3. However, the size of the character 4 or the article object may be adjusted. For example, when the control unit 340 determines that the scene object 5 is a size equal to or larger than the square range of the camera 3, or when the scene object 5 is sized equal to or larger than the square range of the camera 3, the control unit 340 determines whether or not the size of the other object relative to the scene object 5 is appropriate. For example, if the controller 340 has a larger size of the character 4 than the size of the scenic object 5, the controller 340 may reduce the size of the character 4 without changing the size of the scenic object 5.

<Size Optimization when User Possesses>

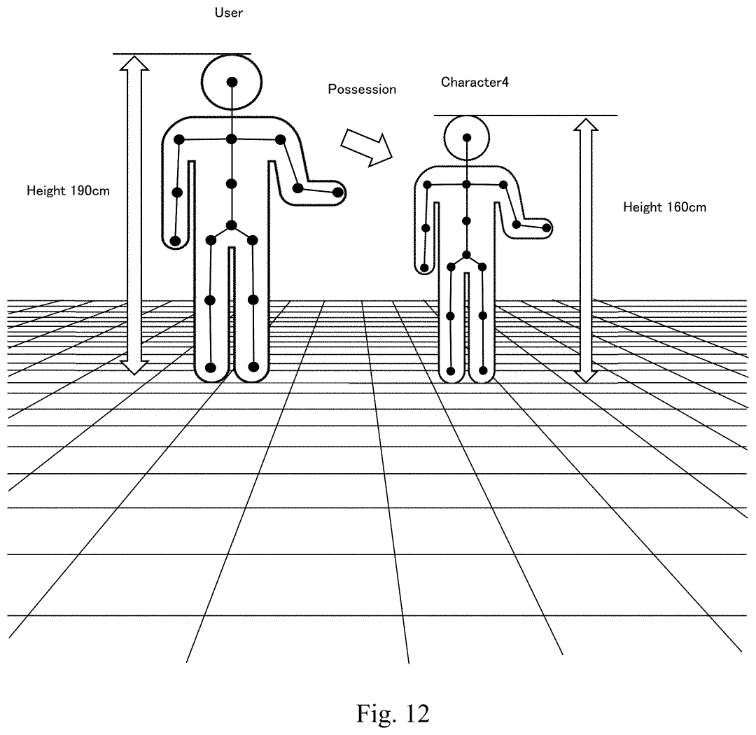

FIG. 12 is a diagram illustrating an optimization when a user possesses a character in an animation production system according to the present embodiment. As shown in the figure, when the user possesses the character 4, the control unit 340 adjusts the skeleton corresponding to the height of the user to the skeleton corresponding to the height of the character 4 when the user enters the user's own height. Specifically, the user is a male with a height of 190 cm, and the character 4 in the virtual space 1 is a female with a height of 160 cm. When the user enters the fact that he/she possesses the height and character 4 by an input device (not shown), the control unit 340 first generates a virtual skeleton corresponding to the height of the user (e.g., an average body skeleton of a 190 cm male) and adjusts the overall reduction (not only the height, but also the length of the arms and legs, etc.) so that the skeleton corresponds to the height of the character 4. Thereafter, the control unit 340 operates the size-adjusted skeleton in accordance with the skeleton of the character 4.

In addition to the height of the user, the existing motion data can be optimized according to the size of the character 4.

<Optimize Motion Data>

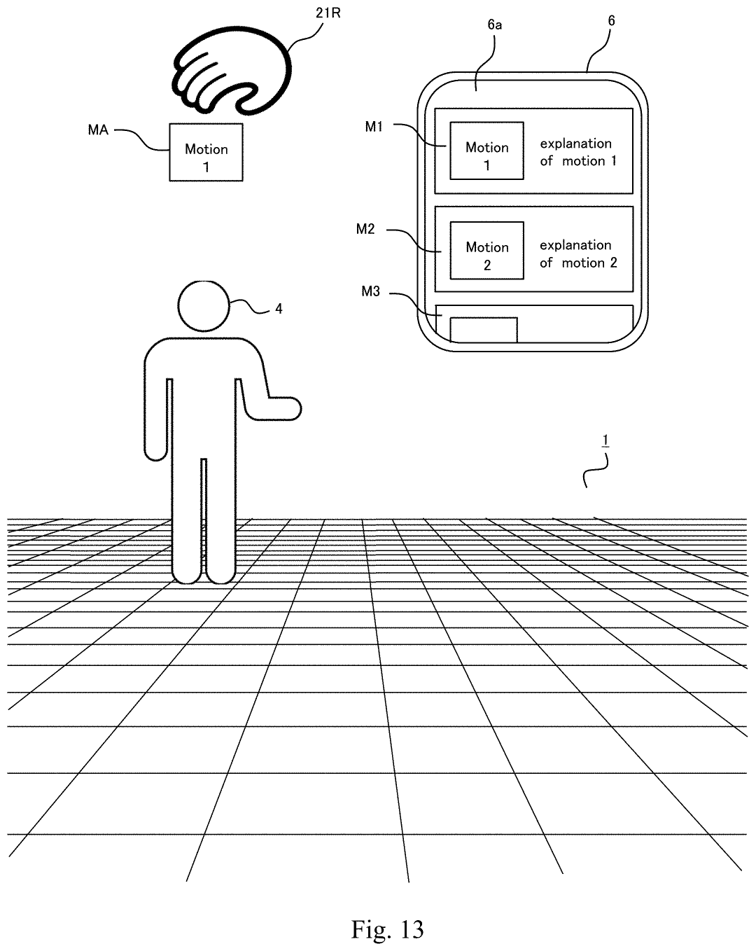

For example, an optimization when using motion data in a character will be described in the present embodiment of FIG. 13. As shown in the figure, a character 4 and an asset store 6 are disposed in the virtual space 1. The asset store 6 is a virtual touch panel in which motion samples M1, M2, and M3 are disposed as assets in the display portion 6a of the panel. Motion samples M1, M2, and M3 have a set of motion thumbnails and motion descriptions. The user can select a motion sample by sliding the panel vertically. For example, a user may depress motion sample 6b to pop up motion asset MA in virtual space 1. The motion asset MA is a block containing motion data that causes the character 4 to move (dance, etc.) in a predetermined manner. In addition, the motion data is data in which the motion of the dancer is read and recorded using, for example, a motion sensor. In addition to motion data, motion assets also include skeletal information (e.g., height, shoulder width) about the dancer that provided the motion.

When the user grabs the motion asset MA via the virtual right hand 21R and hits the character 4, the control unit 340 optimizes the motion asset MA according to the character 4 and causes the character 4 to receive a predetermined motion. Specifically, the control unit 340 reads the skeletal information of the dancer contained in the motion asset MA (e.g., the height of 190 cm and the average body size of a man in its height) and motion data to generate a virtual skeleton. Then, the control unit 340 makes an overall reduction adjustment of the virtual skeleton so as to fit the skeleton (height: 160 cm) of the character 4. The controller 340 then incorporates the virtual skeleton into the character 4 to cause the character 4 to perform a predetermined motion.

<Physical Interaction>

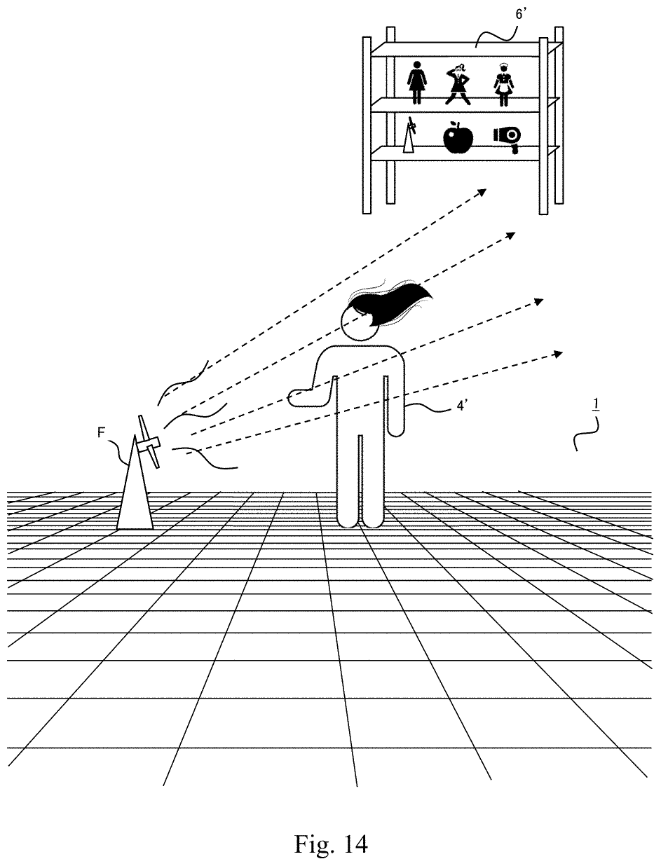

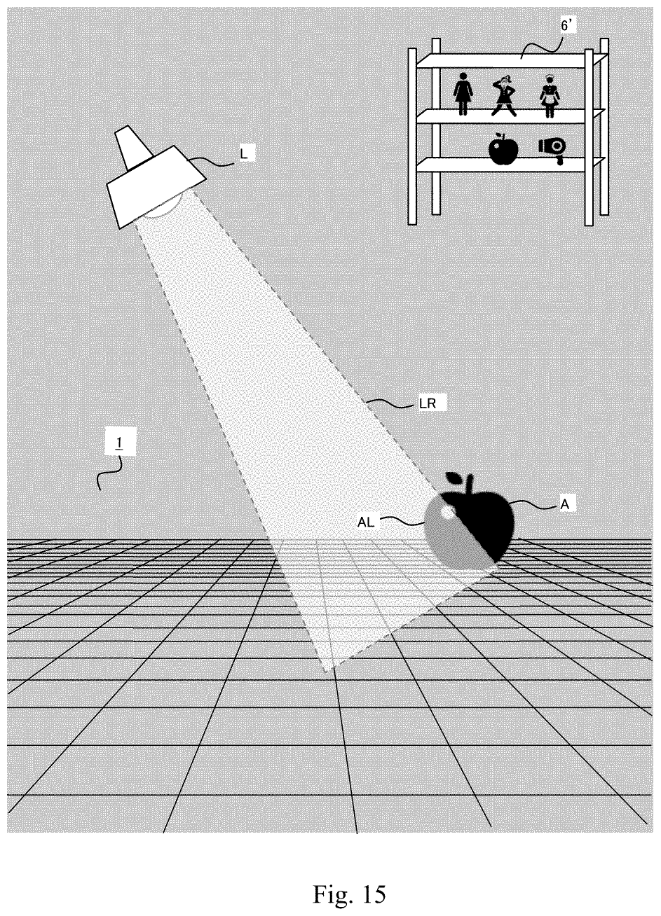

FIGS. 14 and 15 are diagrams illustrating examples of physical interactions between objects and will be described in accordance with these figures. The control unit 340 of the animation production system 300 described hereafter includes a physical arithmetic engine (not shown), and the physical arithmetic engine has the function of simulating or representing the effect on objects, etc. dynamically, such as collision or wind force between objects, in the virtual space 1.

FIG. 14 illustrates an example in which the operation of one object (the first object) has a dynamic effect on the other object (the second object). Specifically, a character 4′ (a second object) is disposed in the substantially central portion of the virtual space, and an object (a fan F, a first object) motifed by a fan is disposed on the lower left side of the character 4′. The fan F may be disposed in the virtual space 1 in advance or may be removed from the asset store 6′ as described above. Next, when the user directs operation of the fan F with an indicator device not shown, the controller 340 rotates the blade of the fan F and simultaneously generates a virtual wind toward the upper right. When it is determined that another object exists in the wind path, the control unit 340 causes the other object to represent a state in which wind hits the other object. Specifically, when the character 4′ is disposed on the wind path (shaded line) as shown in the figure, the control unit 340 controls the hair or clothes of the character 4′ in the direction to the upper right. The control section 340 may also vary the manner of snoring, such as hair, depending on, for example, the strength of the wind. In this embodiment, wind power is described as an expression that has a dynamic influence, but this is not limited thereto. For example, there may be expressions that affect the dynamic effects of collisions, involvement, or flow of water between objects.

FIG. 13 illustrates an example in which the operation of one object (the first object) has an optical effect on the other object (the second object). As shown in the figure, an object (light L) with a light motif on the upper left of the virtual space 1 is installed, and an object (apple A) with an apple motif on the lower right is installed. The light L and the apple A may be disposed in the virtual space 1 in advance or may be removed from the asset store 6′ as described above. When the user is instructed to illuminate the light of light L through an indicator device not shown, the controller 340 continues to eject the light beam LR from the light emitting portion toward the lower right. When it is determined that an object exists in the path of the light beam LR, the control unit 340 controls only the part exposed to the path of the light beam LR in the object to brighten. That is, since the portion of apple A from the upper left side to the lower right side is exposed to the light beam LR, the control unit 340 controls so that only the portion AL is bright. In this embodiment, the portion exposed to the light path in the object is said to be brighter, but shadows may be generated.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in the present embodiment, the image generating device 310 may be a single computer, but not limited to the HMD 110 or the controller 210 may be provided with all or some of the functions of the image generating device 310. It may also include a function of a portion of the image generating device 310 to other computers that are communicatively connected with the image generating device 310.

In the present exemplary embodiment, a virtual space based on the virtual reality (VR; Virtual Reality) was assumed. However, the animation production system 300 of the present exemplary embodiment is not limited to an extended reality (AR; Augmented Reality) space or a complex reality (MR; Mixed Reality) space, but the animation production system 300 of the present exemplary embodiment is still applicable.

### EXPLANATION OF SYMBOLS

1 virtual space
2 cameraman
3 cameras
4 characters
5 objects
6 Asset Store
110 HMD
120 display panel
130 housing
140 sensor
150 light source
210 controller
220 left hand controller
230 right hand controller
235 grip
240 trigger button
250 Infrared LED
260 sensor
270 joystick
280 menu button
300 Animation Production System
310 Image Generator
320 I/O portion
330 communication section
340 controller
350 storage
410 User Input Detector
420 Asset Management Department
430 character control section
440 OBJECT CONTROL PART
450 camera control
460 Image Generator
470 Character Data Storage
480 Control Program Storage
490 Image Data Storage
500 Object Data Storage

1. A system for producing an animation in a virtual space, the system comprising:
an asset management unit that places a first object, a second object, and a virtual camera in the virtual space; and
a control unit that adjusts size of the second object in a coordinate system of the virtual space in accordance with sizes of the first object and a field angle of the virtual camera.

2. The animation production system according to claim 1, wherein the control unit adjusts the height of the second object in accordance with the height of the first object.

3. (canceled)

4. The animation production system according to claim 3, wherein the controller adjusts the size of the second object in the coordinate system of the virtual space to a size equal to or greater than the size of shooting range of the virtual camera.

5. The animation production system according to claim 1, further comprising a storage unit for storing size data of the first object and the second object, wherein the control unit adjusts the size of the second object using a ratio obtained from the size data of the first object stored in the storage unit and the size of the first object in the virtual space.

6. The animation production system of claim 5, wherein the size data is height data.

7. A method for producing animations in a virtual space, wherein
a computer executes:
a step of placing a first object a second object, and a virtual camera in the virtual space; and
a step of adjusting size of the second object in a coordinate system of the virtual space to size of the first object and size of shooting range of the virtual camera in the coordinate system of the virtual space.

8. A non-transitory computer-readable storage medium storing a program for producing an animation in a virtual space,
the program causes a computer to execute:
a step of placing a first object, a second object, and a virtual camera in the virtual space; and
a step of adjusting size of the second object in a coordinate system of the virtual space to size of the first object and size of shooting range of the virtual camera in the coordinate system of the virtual space.
